(19) United States
(12) Patent Application Publication
(10) Pub. No.: US 2011/0002748 A1
(43) Pub. Date: Jan. 6, 2011

(54) METHOD AND APPARATUS IN PNEUMATIC MATERIAL CONVEYING SYSTEM

(76) Inventor: Göran Sundholm, Tuusula (FI)

Correspondence Address: BIRCH STEWART KOLASCH & BIRCH, PO BOX 747, FALLS CHURCH, VA, 22040-0747, US

(21) Appl. No.: 12/809,108

(22) PCT Filed: Dec. 18, 2008
(86) PCT No.: PCT/FI08/50759

§ 371 Date: Jun. 18, 2010

(30) Foreign Application Priority Data
Dec. 21, 2007 (FI) 20075950
Dec. 21, 2007 (FI) 20075951
Feb. 18, 2008 (FI) 20085143

(51) Int. Cl. B65G 53/40; B65G 53/34

(52) U.S. Cl. 406/46; 406/108

(57) ABSTRACT

A method in a pneumatic material conveying system, such as a waste conveying system, which conveying system comprises at least one feed point (61) of material, particularly of waste material, a material conveying pipe (100) which is connectable to the feed point (61), a separator device (20) in which the material being conveyed is separated from conveying air, and means (3) for providing a pressure difference in the conveying pipe (100) at least during the conveyance of the material. At least a part of the conveying piping (100) is connectable as a section of the circuit in which conveying air is circulated and, in the method, at least a part of the conveying piping (100) is flushed and/or dried with air and/or material is conveyed in the circuit by circulating conveying air in the circuit, particularly by blowing in the circuit with a pump device (3).

### BACKGROUND OF INVENTION

The invention relates to a method according to the preamble of claim 1.

The invention also relates to an apparatus according to claim 12.

The invention relates generally to pneumatic conveying systems, such as vacuum conveying systems, particularly to collecting and conveying waste, such as conveying household waste.

Systems are known in which waste is conveyed in a piping by means of suction. In these, waste is conveyed for long distances in the piping by suction. Apparatuses are utilised, inter alia, for conveying waste in different institutions. Typical for them is that a vacuum apparatus is used for achieving a pressure difference, in which apparatus underpressure in the conveying pipe is provided with vacuum generators, such as vacuum pumps or an ejector apparatus. In the conveying pipe, there is typically at least one valve element by opening and closing of which make-up air coming in the conveying pipe is regulated. The vacuum conveying systems typically contain, inter alia, the following problems: high energy consumption, high air flow in the piping, problems with noise, dust and fine particles in the outlet pipe. Furthermore, prior-art apparatuses can have moisture problems. Moisture often accesses the piping which possibly hinders the conveying process or harms the material intended to be conveyed. In rainy weather, the prior-art apparatuses can suck even e.g. 1,000 litres of water per suction from outdoor air. This causes problems with corrosion and blockages. Furthermore, large systems have required arranging several separate make-up air valves, which increases the complexity and costs of the systems. For example, waste paper etc. sticks to the piping when moist.

An object of this invention is to achieve a totally novel arrangement into connection with material conveying systems by means of which the disadvantages of known arrangements are avoided. A second object of the invention is to provide an arrangement applicable for vacuum conveying systems by means of which the noise problems of material feed can be decreased. A third object of the invention is to decrease the production of moisture in the piping. An additional object of the invention is to provide an arrangement by means of which the number of make-up air valves required in the system can be minimised. A further object is to provide an arrangement by means of which the volume of outlet air of the system and, at the same time, emissions of dust and fine particles and possible odour nuisances can be decreased. In addition, an object is to provide an arrangement by means of which it is possible to decrease possible harms caused by moisture in the conveying piping. A yet further object is to provide an arrangement which aims at minimising the total time used for cleaning the piping.

### BRIEF DESCRIPTION OF INVENTION

The method according to the invention is mainly characterised in that at least a part of the conveying piping is connectable as a section of a circuit in which conveying air is circulated and that, in the method, at least a part of the conveying piping is flushed and/or dried with air and/or material is conveyed in the circuit by circulating conveying air in the circuit, particularly by blowing in the circuit with a pump device.

In addition, the method according to the invention is characterised by what is stated in claims 2-11.

The apparatus according to the invention is mainly characterised in that the apparatus comprises a circuit which comprises at least a part of the conveying piping, in which circuit conveying air is circulatable, and that the apparatus comprises means for increasing the flow rate of air and/or for flushing and/or drying at least a part of the conveying piping with air by circulating conveying air in the circuit, particularly by blowing in the circuit with a pump device.

The apparatus according to the invention is further characterised by what is stated in claims 13-24.

The arrangement according to the invention has numerous significant advantages. By arranging the piping of the system to comprise a circuit where at least part of conveying air circulates, the volume of outlet air can be decreased. At the same time, the energy consumption of the system is minimised. By arranging an ejector device on the blowing side of the pump device of conveying air, the actuating medium of which is outlet air of the pump device, an extremely effective blowing effect is provided in the circuit. By maintaining underpressure and simultaneously blowing, it is possible to provide an effective circulation of conveying air in the circuit and conveyance of material in the conveying pipe. With the arrangement according to the invention, the flow rate of air can be increased in the piping and thus, if required, the conveyance of material in the piping can be improved. With the arrangement according to the invention, it is possible to decrease the volume of outlet air substantially and simultaneously to decrease possible problems with dust and fine particles in the outlet pipe. The arrangement according to the invention also substantially decreases the noise problem caused by prior art. Moisture accumulated in the piping is minimised and the piping can be dried by circulating air in the piping. Furthermore, by increasing the flow rate of air, it is better possible to keep the piping clean. By heating air, the drying process can be quickened. The arrangement according to the invention can be advantageously used e.g. after cleaning the piping and/or in connection with changing the material type. As the volume of air being sucked inside decreases, also energy consumption decreases. By opening and closing the feed points of the system according to the invention, the material is provided with an effective transfer into and conveyance in the conveying pipe when, at the same time, the noise effect caused by the operation of the system can be minimised. By arranging the conveying pipe of the material conveying system to consist of operating areas i.e. partial circuits, it is possible to effectively arrange the conveyance of the material in the conveying piping and emptying the feed points into the conveying pipe. By arranging the conveying air circulation in the reverse direction, an effective removal of blockings is provided. In a circular piping, it is easily possible to arrange the change of the conveying air circulation in the reverse direction. Air heats up when compressing, such as in a vacuum pump of a vacuum unit, whereby the drying process is simultaneously intensified when heated air is circulated in the piping. By air flushing and drying, the conveyance of material particles in the conveying piping can be improved. On the other hand, it is also possible to prevent the formation of moisture in the conveying piping hindering the conveyance of material. Furthermore, possible odour nuisances possibly caused by material particles remaining in the piping can be minimised, because it is now possible to convey them more effectively to the separator device and further to the material container. It is also easier to keep the piping clean, when the intensified air flushing according to the invention can be utilised. The air flushing also quickens the re-commissioning of the apparatus after a possible wash of the piping.

Depending on the target of application, several pump devices can be connected to blow and/or suck in the piping, whereby it is possible to further intensify air circulation in the piping.

### BRIEF DESCRIPTION OF FIGURES

In the following, the invention will be described in detail by means of an example with reference to the accompanying drawings in which

FIG. 1 schematically shows a system according to an embodiment of the invention,

FIG. 1a shows a part of a system according to the invention as simplified,

FIG. 2 schematically shows a system according to an embodiment of the invention in a second operating mode,

FIG. 3 schematically shows a system according to an embodiment of the invention in a third operating mode, and

FIG. 4 schematically shows a system according to an embodiment of the invention in a fourth operating mode.

### DETAILED DESCRIPTION OF INVENTION

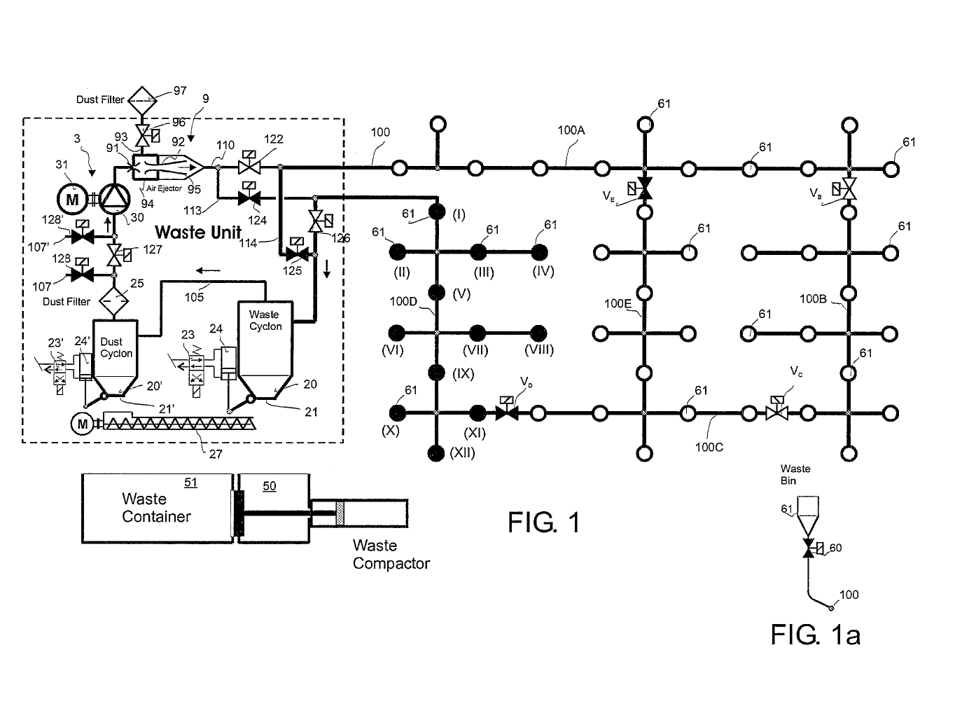

FIG. 1 shows a pneumatic material conveying system according to an embodiment of the invention, particularly a waste conveying system, as a simplified schematic diagram. The figure shows a material conveying pipe 100 along which is arranged at least one, typically several feed points 61. The feed point 61 is a feed station of material, particularly of waste material, intended to be conveyed, from which point the material, particularly waste material, such as household waste, intended to be conveyed is fed to the conveying system. The system can comprise several feed stations 61 from which the material intended to be conveyed is fed to a conveying piping 100A, 100B, 100C, 100D, 100E. The feed station 61 is designated in the figure with a point, whereby by opening and closing a gate element in connection with the feed station, such as a valve element 60, material can be conveyed from the feed point 61 to the conveying pipe 100. FIG. 1a shows a feed point 61 used in the system according to the invention and its outlet valve 60 in more detail. The feed point is connected on the side of the valve to the conveying pipe 100 or a pipe being in connection with it. Typically, the conveying piping comprises a main conveying pipe 100 into which several branch conveying pipes can have been connected and into which again several feed stations 61 can have been connected. The fed material is conveyed along the conveying piping 100, 100A, 1008, 100C, 100D to a separator device 20 in which the material being conveyed is separated, e.g. due to dropping rate and centrifugal force, from conveying air. The separated material is removed, e.g. when required, from the separator device 20 to a material container, such as a waste container 51, or to further treatment. The material container can comprise, as in the embodiment of the figures, a waste compactor 50, with which the material is compacted by compressing into smaller size, and from which the material is further conveyed to the waste container 51. In the embodiment of FIG. 1, the separator device 20 is provided with material outlet elements 21, 24. From the separating device 20, a conveying air channel 105 leads to means 3 for generating underpressure in the conveying pipe. In the embodiment of FIG. 1, the means for generating underpressure comprise a pump device 3, such as a vacuum pump unit. With the means for generating underpressure, underpressure required for conveying the material is provided in the conveying piping 100 and/or its section. The vacuum pump unit 3 comprises a vacuum pump 30 which is operated by an actuator 31. The system comprises means for circulating conveying air in the circuit, a section of which is formed by at least a part of the conveying piping 100, 100A, 1008, 100C, 100D, 100D, 100E. In the embodiment of FIG. 1, the conveying piping 100 is dividable into operating areas or partial circuits 100A, 1008, 100C, 100D, 100E by valve elements V_{B}, V_{C}, V_{D} i.e. area valves.

FIG. 1 shows a situation in which the valve element V_{D} is closed, whereby conveying air is not able to circulate in the circuit. The suction side of the vacuum generator 3 being connected directly or by means of the conveying air channel 105 to at least one separator device 20, 20′ in which again the delivery end of the conveying pipe 100 is connected, underpressure is provided in the conveying pipe to at least the section of the circuit which is in the material conveying direction between at least one valve, in FIG. 1 the valve V_{D}, and the separator device 20. The conveying direction of material and the travel direction of air are designated with arrows in FIG. 1. Underpressure prevails also in the section of the circuit between the separator device 20 and the vacuum generator 3, i.e. in the conveying air channel 105, in the embodiment of the figure also in the second separator device 20′ i.e. a dust separator, and the section of the conveying air channel 105 extending from it to the vacuum generator 3. In a case according to the figure, when opening in the feed point 61 its valve element 60, a material portion intended to be conveyed is conveyed to the conveying pipe 100, in the figure to the section 100D of the conveying pipe, to be conveyed further to the separator device 20. Possible make-up air in the conveying pipe comes e.g. via the feed point 61 when opening the valve 60 in the conveying pipe.

The blowing side of the vacuum pump 30 of the pump device 3 in the embodiment of FIG. 1 is arranged to blow in an ejector device 9 in the operating mode in question. The ejector device 9 is arranged between the pump device 3 and the conveying piping 100 so that an ejector nozzle 91 of the ejector device 9 is connected to a channel 110 coming from the blowing side of the pump device. Then, as the actuating medium of the ejector 9 operates conveying medium, typically air, of the blowing side of the pump device 3, such as a vacuum generator. The ejector device 9 comprises an ejector pipe 92 in which the ejector nozzle 91 is arranged to direct a medium spray. The ejector device comprises a chamber space 94 in which the ejector nozzle 91 and the first end of the ejector pipe 92 and a fitting 93, via which is openable and closable a connection outside the chamber space 94, are arranged. When the ejector nozzle 91 sprays the medium in the ejector pipe 92, suction is provided which draws extra air along with it via the fitting 93. A blowing side 95 of the ejector device 9 is connected to the conveying pipe 100 or the channel 110 leading to the conveying pipe. The operating principles of the ejector device are considered known as such to those skilled in the art and they will not be examined in more detail. From the influence of the ejector 9, a considerable increase is provided in the main flow blown by the pump device 3 due to an extra air flow via the fitting 93, typically in the range of 20-60%. With the combination of the pump device 3 and the ejector 9, an increase is thus provided in the conveying air flow by means of which it is possible to effectively provide overpressure on the blowing side of the pump and/or underpressure and/or a suction effect on the suction side of the pump device. In the fitting 93 is arranged a valve element 96 and a filter element 97, such as a dust filter. In certain cases, the fitting 93 can also operate as an outlet channel.

From the blowing side of the ejector 9 is arranged a connection, e.g. via the air channel 110, to the conveying pipe 100 on its supply side. In the air channel 110 of the blowing side is arranged a valve element 122 which, when closed, prevents a connection of the blowing side to the usual supply side of the conveying pipe 100.

The operation of the system is controlled so that, for emptying the feed points of a desired operating area, at least one valve is open in the material conveying direction in relation to the operating area of the conveying pipe 100 and on the supply side of the conveying air i.e. on the side of suction, whereby the suction is able to affect the conveying pipe of the operating area. Let us assume that, in the arrangement according to the figure, the feed points 61 of the conveying pipe area 100D are to be emptied. Then, all area valves between the separator element 20 and the operating area in the conveying pipe 100 (the section 100D of the conveying pipe in the figure) in the conveying direction are open (a valve 126 in the figure). Then, suction provided by at least one vacuum generator 3 prevails in the conveying piping 100D in the operating area. At least one valve V_{D} on the blowing side of the conveying pipe 100 is closed, whereby only suction prevails in the operating area. The feed points 61 of the operating area or at least part of them are emptied so that the connection of the feed point 61 (I) closest to the delivery end in the conveying direction of the conveying pipe, i.e. in the embodiment according to the figure closest to the separator device 20, to the conveying pipe 100D is opened first, whereby the material is able to convey from the first feed point to the conveying pipe, and before the connection of the first feed point (I) to the conveying pipe closes, the connection of the next feed point 61 (II) to the conveying pipe is opened. In the embodiment of the figure, this is, when travelling against the material conveying direction, the next feed point 61 (II) intended to be emptied. After this, the connection of the first feed point 61 (I) is closed to the conveying pipe. Equivalently, the connection of the third feed point 61 (III) intended to be emptied to the conveying pipe is opened before the connection of the second feed point 61 (II) to the conveying pipe is closed. This operation is repeated until all desired feed points have been emptied. In the figure, it has been considered emptying all the feed points 61 of the conveying pipe area 100D, whereby their emptying sequence to the conveying pipe 100, 100D is designated in the figure by numerals within parentheses: (I), (II), (III), (IV), (V), (VI), (VII), (VIII), (IX), (X), (XI), and (XII). When the passage of the last feed point 61 (XII) intended to be emptied in the operating area to the conveying pipe 100 has been opened, the material has conveyed to the conveying pipe 100, 100D, and the passage of the feed point to the conveying pipe is closed, a connection is opened in the conveying pipe 100D of the operating area from the blowing side by opening at least one valve element V_{D} which is between the operating area and the pump device 3 blowing to the conveying pipe 100. Then, an intensified conveying effect (suction and blowing together) is provided for the material being conveyed transferred in the conveying pipe 100, 100A, 100B, 100C, 100D. The conveying air circulates on a route designated with arrows in the figure, whereby material portions conveyed from the feed points to the conveying pipe convey in the conveying piping further to the separator device 20 in which the material being conveyed is separated from conveying air. In the figure, the area valve V_{E} of the conveying pipe 100E of the operating area is closed, whereby conveying air is not able to access the conveying pipe 100E of the operating area but circulates on the route of the conveying pipe of the area via 100A, 100B, 100C, 100D. In connection with the emptying of different operating areas, the material conveying route from the operating area to a delivery station, such as to the separator element 20, can be optimised by keeping the area valves open along the desired conveying route.

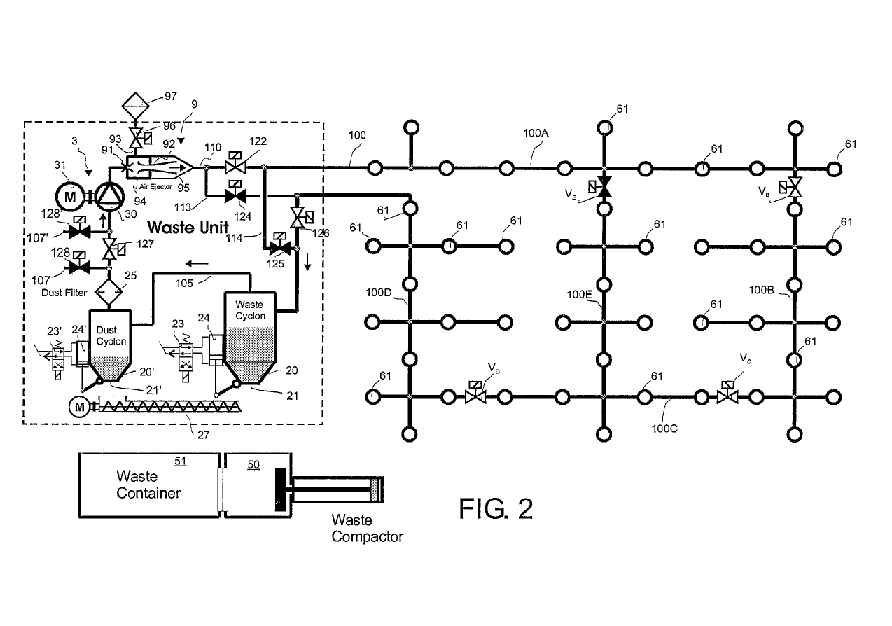

FIG. 2 shows an operating mode of a system according to the invention in which conveying air is able to circulate in the circuit, a section of which is formed by at least a part of the conveying pipe 100 and in which in the embodiment of the figure belong the separator device 20, the conveying air channel 105, the possible second separator device 20′ and from the blowing side of the vacuum generator the air channel 110 on the supply side of the conveying pipe 100. The vacuum generator 3 is arranged to circulate air in the circuit and to provide a suction effect in the conveying pipe 100, at least its delivery end, i.e. in the conveying direction at the end on the side of the separator element 20. According to the embodiment of the figure, the vacuum generator 3 is also arranged to provide a blowing effect in the conveying pipe, in the figure via the air channel 110 and the ejector device 9. One or more area valves of the conveying pipe 100, in the figure area valves V_{B}, V_{C}, V_{D} and the valve 122 and 126, are in the open position, whereby conveying air is able to circulate in the circuit, a section of which is formed by at least a part of the feed pipe 100, whereby material portions fed in the conveying pipe from one or more feed stations 61 move towards the separator device 20. In the ejector device, to a main flow produced by the pump device is combined an additional flow coming from the fitting 93 which is led, due to the suction provided by the ejector device, from the fitting 93 to the ejector in which it is mixed with the main flow. Then, with the pump device together with the ejector, an extremely effective blowing effect is provided in the circuit on its supply side and a suction effect on the side of the separator element i.e. on the return side.

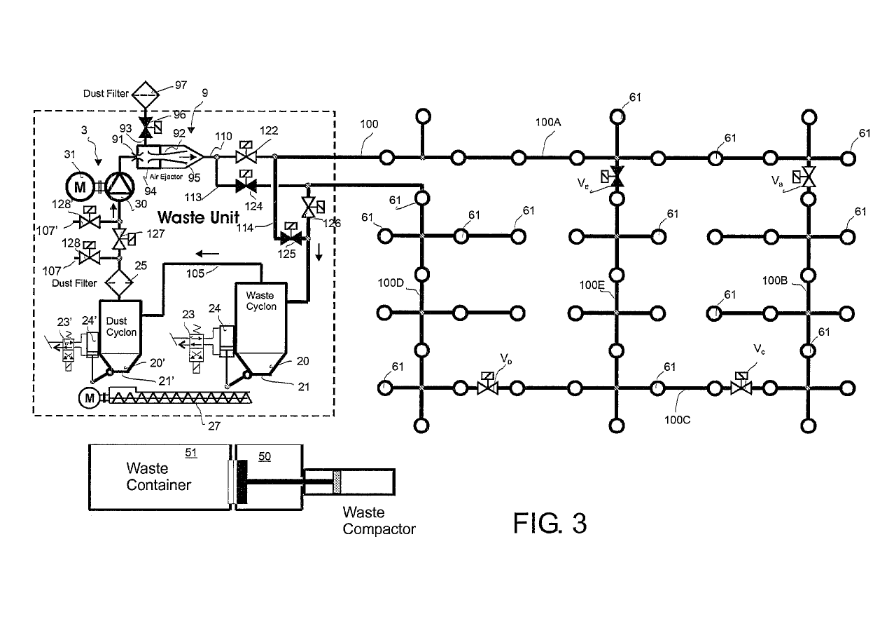

FIG. 3 shows an operating mode of a system in which a connection to an outlet channel, which is in the embodiment of the figure the fitting 93 of the ejector 9, is closed by means of the valve 96. Then, there is a connection from the blowing side of the pump device 3 via the air channel 110 on the supply side of the conveying pipe 100. The pump device circulates air in the circuit a section of which is formed by the conveying piping. In the embodiment of the figure, there has also been arranged at least one fitting 107, 107′ in which there is a valve 128, 128′ by opening of which extra air can be brought on the suction side of the pump device 3 from outside the circuit. By opening the valve 128, 128′, it is possible to raise the pressure of air in the conveying pipe if required and to provide an increased blowing effect in the circuit. In the embodiment of the figure, the valve 128, 128′ of at least one fitting 107, 107′ is open, whereby it is possible to bring extra air on the suction side of the pump device 3 from outside the circuit. By opening the valve 128, 128′, it is then possible to raise the pressure of air in the conveying pipe if required and to provide an increased conveying rate of conveying air. The embodiment of FIG. 3 is particularly well applicable in the air flushing of the piping. With the embodiment of the figure, it is also possible to dry the piping. With the vacuum generator is then advantageously provided a greater flow rate to the pressure side than the suction side. Air heats up when compressing, whereby the drying process is also intensified.

In the embodiment of the figure, the inlet air fitting 107 is between at least one separator device 20 and pump device, such as a vacuum generator 3, in the circulation direction of air. By opening the valve 128, it is then possible to raise the pressure of air in the conveying pipe if required and to provide an increased flow rate.

Air heats up when compressing, such as in a vacuum pump of a vacuum unit, whereby the drying process is simultaneously intensified when heated air is circulated in the piping. By air flushing and drying, the conveyance of material particles in the conveying piping can be improved. On the other hand, it is also possible to prevent the formation of moisture in the conveying piping hindering the conveyance of material. Furthermore, possible odour nuisances possibly caused by material particles remaining in the piping can be minimised, because it is now possible to convey them more effectively to the separator device 20, 20′ and further to the material container 51. It is easier to keep the piping clean by using the intensified air flushing. The air flushing also quickens the re-commissioning of the apparatus after a possible wash of the piping. Depending on the target of application, several pump devices can be connected to blow and/or suck in the piping, whereby it is possible to further intensify air circulation in the piping.

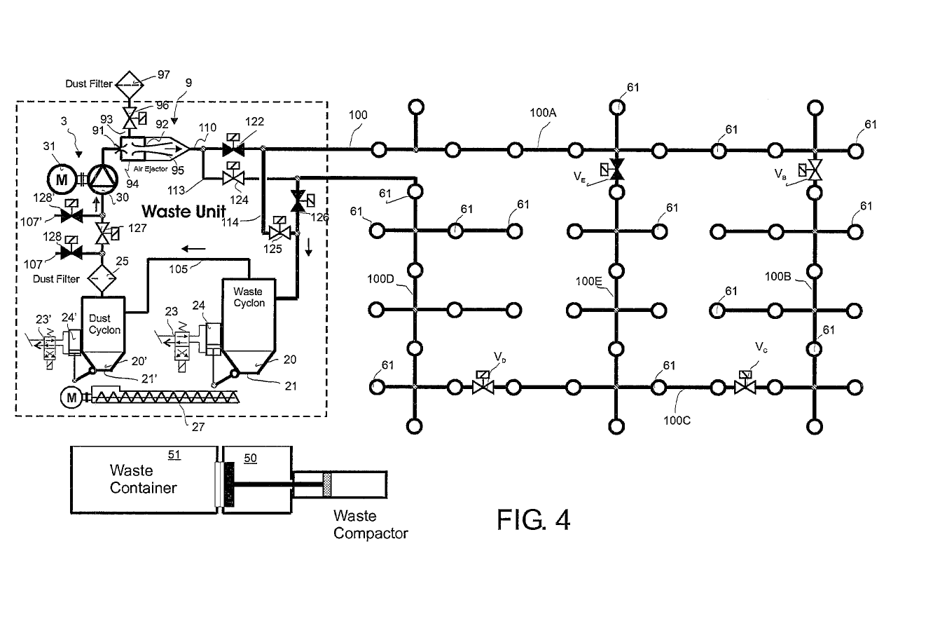

FIG. 4 shows a further embodiment of a system according to the invention in which there is an operating mode by which the circulation direction of conveying air can be reversed at least in a section of the circuit. This can be utilised e.g. in a possible malfunction situation in which a blockage has been formed in the conveying piping 100, 100A, 100B, 100C, 100D, 100E. In the conveying pipe is arranged on the supply side at a distance from the separator device 20 the valve element 126, at the reverse side of which in relation to the separator element is arranged an air channel 113 in which the blowing side of the pump device 3 is connectable. Equivalently, in the air channel 110 of the blowing side is arranged the valve element 122 which, when closed, prevents a connection of at least the blowing side of the pump device 3 to the usual supply side of the conveying pipe 100. From the blowing side of the vacuum unit is arranged a medium passage 113 to the conveying piping 100 on its reversed supply side. In the conveying pipe 100 is formed a channel section 114 which is connected to the conveying pipe in a section between the valve element 126 and the separator device 20 or directly to the separator device, whereby the circulation direction of conveying air is reversed only in a section of the circuit, mainly in the section of the conveying pipe 100. Then, possible blockages are sucked “backwards” in relation to the normal circulation direction.

The invention thus relates to a method in a pneumatic material conveying system, such as a waste conveying system, which conveying system comprises at least one feed point 61 of material, particularly of waste material, a material conveying pipe 100 which is connectable to the feed point 61, a separator device 20 in which the material being conveyed is separated from conveying air, and means 3 for providing a pressure difference in the conveying pipe 100 at least during the conveyance of the material. At least a part of the conveying piping 100 is connectable as a section of the circuit in which conveying air is circulated and, in the method, at least a part of the conveying piping 100 is flushed and/or dried with air and/or material is conveyed in the circuit by circulating conveying air in the circuit, particularly by blowing in the circuit with a pump device.

According to an embodiment the invention, at least part of conveying air on the pressure side of the pump is led in the circuit on the supply side of the conveying pipe 100 via the ejector device 9.

According to another embodiment, in the method, the actuating medium of the ejector device is blowing air of the pump device 3.

According to a further embodiment of the invention, at least part of blowing air of the pump device 3 is employed as the actuating medium of the ejector device 9.

According to an embodiment of the invention, the circulation of air in the circuit, which comprises at least a part of the conveying piping 100, is regulated and/or controlled and/or opened or closed by gate/regulating elements, such as valve elements 122, 124, 125, 126, 127, V_{B}, V_{C}, V_{D}, which are arranged in the circuit.

According to an additional embodiment of the invention, in the method, in the circuit is brought make-up air via at least one air inlet 107, 107′ which advantageously comprises a valve element 128, 128′.

According to an embodiment of the invention, in the method, underpressure is also provided in the circuit with at least one pump device 3, 4, such as a vacuum generator and/or a blower, the suction side of which is connected to the separator element 20 or to the conveying pipe 100 via the air channel 105 leading to it.

According to a yet further embodiment, in the method, make-up air is brought on the suction side of at least one pump device, most advantageously in the section of the circuit between the separator device 20 and the pump device, such as the vacuum generator 3.

According to an advantageous embodiment, in the method, heated air is circulated in the circuit.

According to an embodiment, in the method, the conveying air circulation is connected in the reverse direction at least in a section of the circuit, which section is formed by at least a part of the conveying pipe 100.

According to an advantageous embodiment, the method is utilised at least after the wash of the conveying piping 100.

According to a yet further embodiment, the method is utilised in connection with the change of the material type being conveyed.

The invention also relates to an apparatus in a pneumatic material conveying system, such as a waste conveying system, which comprises at least one feed point 61 of material, particularly of waste material, a material conveying pipe 100 which is connectable to the feed point 61, a separator device 20 in which the material being conveyed is separated from conveying air, and means 3 for providing a pressure difference in the conveying pipe 100 at least during the conveyance of the material. The apparatus comprises a circuit which comprises at least a part of the conveying piping 100, in which circuit conveying air is circulatable, and the apparatus comprises means for increasing the flow rate of air and/or for flushing and/or drying at least a part of the conveying piping 100 with air by circulating conveying air in the circuit, particularly by blowing in the circuit with a pump device 3.

According to an advantageous embodiment, the apparatus comprises an ejector device 9 which is arranged in the circuit on the blowing side of the pump device 3 between the pump device 3 and the conveying pipe 100.

According to a typical embodiment, the actuating medium of the ejector device is blowing air of the pump device 3.

The ejector device comprises at least one fitting 93 for leading another medium flow in the actuating medium flow. In the embodiment of the figure, the fitting can operate as an inlet fitting, whereby air is led via it in the circuit, and/or as an outlet fitting, whereby air is removed via it from the circuit. The fitting 93 is provided with a filter element 97 and a valve element 96 in the embodiment of the figures.

Typically, in the circuit, which comprises at least a part of the conveying piping 100, are arranged gate/regulating elements, such as valve elements 122, 124, 125, 126, 127, V_{B}, V_{C}, V_{D}, by means of which the circulation of conveying air can be regulated and/or controlled and/or opened or closed.

The apparatus typically comprises at least one air inlet 107, 107′, 93 which advantageously comprises a valve element 128, 128′, 96 for bringing air in the circuit from outside it.

Advantageously, the means for providing a pressure difference comprise at least one pump device 3 the suction side of which is connected to the separator element 20 or the air channel 105 leading to it.

According to another embodiment, the means for providing a pressure difference comprise at least one pump device 3 and means 110, 122; 113, 124 for connecting the blowing side of at least one pump device 3 to blow in the circuit.

According to a yet further advantageous embodiment, the apparatus comprises means for flushing at least a part of the conveying piping 100 with air and/or for drying by circulating the conveying air in the circuit, particularly by blowing.

According to another embodiment, the apparatus comprises means 113, 114, 122, 124, 125, 126 for connecting the conveying air circulation in the reverse direction in at least a section of the circuit, which section is formed by at least a part of the conveying pipe 100.

According to a yet further embodiment, the apparatus comprises means 107, 107′, 128, 128′ for bringing make-up air on the suction side of the pump device, most advantageously in the section of the circuit between the separator device 20 and the pump device 3, such as the vacuum generator.

According to an advantageous embodiment, the material feed points 61 are waste feed points, such as waste bins or waste chutes.

According to a further embodiment, the type of the pump device 3 is a pump device heating air. The pump device heats up the air when pumping or the air heats up in the pumping occasion, whereby the air of the pressure side is warmer than the air of the suction side.

The suction being greater than the blowing, which is the target in the system according to the invention, material fed to the conveying pipe, particularly waste material, will not be compressed and compacted, but will be able to travel “freely” in the pipe conveyed by conveying air. Then, the potential of the material being conveyed to form blockages is considerably lower than in a situation in which the blowing is greater than the suction, whereby there is a risk that the material being conveyed will accumulate and block the conveying pipe. Furthermore, underpressure decreases the power required to convey the material, because even partial underpressure in relation to the material portion being conveyed on the side of the conveying direction considerably decreases air drag, among others. In the figure, arrows designate the direction of motion of air in the piping in the operating mode.

The outlet valve 60 of the feed point 61 is opened and closed so that material portions of suitable size are conveyed from the feed point 61 to the conveying pipe 100. Material is fed from the feed point 61, such as a waste container, when after the container is full, the outlet valve 60 is opened either automatically or manually.

The system typically operates as follows: An outlet hatch 21, 21′ of at least one separator device 20, 20′ is closed and the valve 126 between the main conveying pipe 100 and the separator device 20 is open. The pump unit 3 maintains underpressure in the main conveying pipe 100.

All outlet valves 60 in the vicinity of the feed points 61 i.e. waste containers are closed. In the start situation 100, the valve V_{D} is closed.

Let us assume that a waste container of the feed point 61 belonging to the circuit of the operating area 100D of the conveying pipe 100 is to be emptied. Based on an emptying signal, the outlet valve 60 is momentarily opened, e.g. for 2-10 seconds, whereby the material being conveyed, such as waste material, conveys from the effect of underpressure to the conveying pipe 100D. The outlet valve 60 is typically closed after a few seconds after the start situation. The vacuum pump unit 3 maintains desired underpressure. The valve V_{D} is opened, whereby in the circuit of the piping is provided air circulation and possibly also a blowing effect i.e. pressure effect and suction effect which conveys the material portion being conveyed along the piping to the separator device 20. One or more feed points 61 are emptied. According to an advantageous embodiment, the one of the feed points of the desired operating area which is in the conveying direction closest to the separator device 20 is emptied first, and then the next closest feed point and so on until the desired feed points have been emptied.

When the separator device 20 is full, the valve 126 of the conveying pipe 100 closes and a control valve 23 opens, whereby the actuator 24 of the outlet hatch 21 of the separator device opens the outlet hatch 21 and the material accumulated in the separator device is emptied in the compactor device 50 and further in the waste container 51. The outlet hatch 21 of the separator device 20 is closed and the valve 126 opened.

After this, the start situation is reverted and the emptying process can be repeated or the emptying of some other feed point/feed points can be implemented.

The waste container 51, such as a waste freight container, is replaced or emptied when it is full.

The system can also comprise several separator devices 20, 20′ in which material conveyance is controlled, e.g. based on the sort of the material or the capacity of the system.

It is obvious to those skilled in the art that the invention is not limited to the embodiments described above, but it may be varied within the scope of the enclosed claims. When necessary, the features possibly described in this specification together with other features may also be used separately from each other.

1. A method in a pneumatic material conveying system, such as a waste conveying system, which conveying system comprises at least one feed point (61) of material, particularly of waste material, a material conveying pipe (100) which is connectable to the feed point (61), a separator element (20) in which the material being conveyed is separated from conveying air, and means (3) for providing a pressure difference in the conveying pipe (100) at least during the conveyance of the material, characterised in that at least a part of the conveying piping (100) is connectable as a section of a circuit in which conveying air is circulated and that, in the method, at least a part of the conveying piping (100) is flushed and/or dried with air and/or material is conveyed in the circuit by circulating conveying air in the circuit, particularly by blowing in the circuit with a pump device (3).

2. A method according to claim 1, characterised in that at least part of conveying air on the pressure side of the pump is led in the circuit on the supply side of the conveying pipe (100) via an ejector device (9).

3. A method according to claim 1, characterised in that at least part of blowing air of the pump device (3) is used as the actuating medium of the ejector device (9).

4. A method according to claim 1, characterised in that the circulation of air in the circuit, which comprises at least a part of the conveying piping (100), is regulated and/or controlled and/or opened or closed by gate/regulating elements, such as valve elements (122, 124, 125, 126, 127, V_{B}, V_{C}, V_{D}), which are arranged in the circuit.

5. A method according to claim 1, characterised in that, in the method, in the circuit is brought make-up air via at least one air inlet (107, 107′) which advantageously comprises a valve element (128, 128′).

6. A method according to claim 1, characterised in that, in the method, underpressure is also provided in the circuit with at least one pump device (3, 4), such as a vacuum generator and/or a blower, the suction side of which is connected to the separator element (20) or to the conveying pipe (100) via an air channel (105) leading to it.

7. A method according to claim 1, characterised in that, in the method, make-up air is brought on the suction side of at least one pump device, most advantageously in a section of the circuit between the separator device (20) and the pump device, such as a vacuum generator (3).

8. A method according to claim 1, characterised in that, in the method, heated air is circulated in the circuit.

9. A method according to claim 1, characterised in that, in the method, the conveying air circulation is connected in the reverse direction at least in a section of the circuit, which section is formed by at least a part of the conveying pipe (100).

10. A method according to claim 1, characterised in that the method is utilised at least after the wash of the conveying piping (100).

11. A method according to claim 1, characterised in that the method is utilised in connection with the change of a material type.

12. An apparatus in a pneumatic material conveying system, such as a waste conveying system, which comprises at least one feed point (61) of material, particularly of waste material, a material conveying pipe (100) which is connectable to the feed point (61), a separator element (20) in which the material being conveyed is separated from conveying air, and means (3) for providing a pressure difference in the conveying pipe (100) at least during the conveyance of the material, characterised in that the apparatus comprises a circuit which comprises at least a part of the conveying piping (100), in which circuit conveying air is circulatable, and that the apparatus comprises means for increasing the flow rate of air and/or for flushing and/or drying at least a part of the conveying piping (100) with air by circulating conveying air in the circuit, particularly by blowing in the circuit with a pump device (3).

13. An apparatus according to claim 12, characterised in that the apparatus comprises an ejector device (9) which is arranged in the circuit on the blowing side of the pump device (3) between the pump device (3) and the conveying pipe (100).

14. An apparatus according to claim 12, characterised in that the actuating medium of the ejector device is blowing air of the pump device (3).

15. An apparatus according to claim 12, characterised in that the ejector device comprises a fitting (93) for leading another medium flow in the actuating medium flow.

16. An apparatus according to claim 12, characterised in that, in the circuit, which comprises at least a part of the conveying piping (100), are arranged gate/regulating elements, such as valve elements (122, 124, 125, 126, 127, V_{B}, V_{C}, V_{D}), by means of which the circulation of conveying air can be regulated and/or controlled and/or opened and closed.

17. An apparatus according to claim 12, characterised in that the apparatus comprises at least one air inlet (107, 107′, 93) which advantageously comprises a valve element (128, 128′, 96) for bringing air in the circuit from outside of it.

18. An apparatus according to claim 12, characterised in that the means for generating a pressure difference comprise at least one pump device (3) the suction side of which is connected to the separator element (20) or an air channel (105) leading to it.

19. An apparatus according to claim 12, characterised in that the means for providing a pressure difference comprise at least one pump device (3) and means (110, 122; 113, 124) for connecting the blowing side of at least one pump device (3) to blow in the circuit.

20. An apparatus according to claim 12, characterised in that the apparatus comprises means for flushing at least a part of the conveying piping (100) with air and/or drying by circulating conveying air in the circuit, particularly by blowing.

21. An apparatus according to claim 12, characterised in that the apparatus comprises means (113, 114, 122, 124, 125, 126) for connecting the conveying air circulation in the reverse direction at least in a section of the circuit, which section is formed by at least a part of the conveying pipe (100).

22. An apparatus according to claim 12, characterised in that the apparatus comprises means (107, 107′, 128, 128′) for bringing make-up air on the suction side of the pump device, most advantageously in a section of the circuit between the separator device (20) and the pump device (3), such as a vacuum generator.

23. An apparatus according to claim 12, characterised in that the material feed points (61) are waste feed points, such as waste bins or waste chutes.

24. An apparatus according to claim 12, characterised in that the type of the pump device (3) is an air heating pump device.
